(19) United States
(12) Patent Application Publication
(10) Pub. No.: US 2017/0315655 A1
(43) Pub. Date: Nov. 2, 2017

(54) CHARGE SHARE FOR CAPACITIVE SENSING DEVICES

(71) Applicant: SYNAPTICS INCORPORATED, San Jose, CA (US)

(72) Inventor: John Michael WEINERTH, San Jose, CA (US)

(21) Appl. No.: 15/199,322

(22) Filed: Jun. 30, 2016

Related U.S. Application Data
(60) Provisional application No. 62/330,514, filed on May 2, 2016.

(51) Int. Cl. G06F 3/041

(52) U.S. Cl. CPC G06F 3/0416; G06F 3/041

(57) ABSTRACT

An input device and associated processing system and method are disclosed for operating a plurality of sensor electrodes. The method comprises driving, during a first period, a first portion of a plurality of sensor electrodes to a first voltage. The first portion corresponds to a first number of sensor electrodes. The method further comprises driving, during the first period, a second portion of the plurality of sensor electrodes to a second voltage less than the first voltage. The second portion corresponds to a second number of sensor electrodes. The first number and second number are based on a plurality of digital codes used to drive the first and second portions. The method further comprises transferring charge between the first portion and second portion to drive the second portion to an intermediate voltage, and driving, during a second period, the second portion from the intermediate voltage to the first voltage.

### CROSS-REFERENCE TO RELATED APPLICATIONS

This application claims benefit of U.S. provisional patent application Ser. No. 62/330,514, filed May 2, 2016 entitled “Charge Share for Capacitive Sensing Devices,” which is herein incorporated by reference.

### BACKGROUND

### Field

Embodiments of the present invention generally relate to techniques for operating an input device having a display device with an integrated sensing device.

### Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

One embodiment described herein is an input device comprising a plurality of sensor electrodes. The input device further comprises a processing system configured to drive, during a first period, a first portion of the plurality of sensor electrodes to a first voltage, the first portion corresponding to a first number of sensor electrodes. The processing system is further configured to drive, during the first period, a second portion of the plurality of sensor electrodes to a second voltage less than the first voltage. The second portion corresponds to a second number of sensor electrodes, and the first number and the second number are based on a plurality of digital codes used to drive the first portion and second portion. The processing system is further configured to transfer charge between the first portion and second portion to drive the second portion to an intermediate voltage between the first voltage and the second voltage, and to drive, during a second period, at least one sensor electrode of the second portion from the intermediate voltage to the first voltage.

Another embodiment described herein is a processing system comprising driver circuitry configured to drive, during a first period, a first portion of a plurality of sensor electrodes to a first voltage, the first portion corresponding to a first number of sensor electrodes. The driver circuitry is further configured to drive, during the first period, a second portion of the plurality of sensor electrodes to a second voltage less than the first voltage. The second portion corresponds to a second number of sensor electrodes, and the first number and second number are based on a plurality of digital codes used to drive the first portion and second portion. The processing system further comprises coupling circuitry configured to selectively couple the first portion and second portion, whereby the second portion is driven to an intermediate voltage between the first voltage and the second voltage. The driver circuitry is further configured to drive, during a second period, the second portion from the intermediate voltage to the first voltage.

Another embodiment described herein is a method comprising driving, during a first period and using driver circuitry, a first portion of a plurality of sensor electrodes to a first voltage, the first portion corresponding to a first number of sensor electrodes. The method further comprises driving, during the first period and using the driver circuitry, a second portion of the plurality of sensor electrodes to a second voltage less than the first voltage. The second portion corresponds to a second number of sensor electrodes, and the first number and second number are based on a plurality of digital codes used to drive the first portion and second portion. The method further comprises transferring charge between the first portion and second portion to drive the second portion to an intermediate voltage between the first voltage and the second voltage, and driving, during a second period, the second portion from the intermediate voltage to the first voltage.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic block diagram of an input device, according to one embodiment.

FIGS. 2 and 3 illustrate portions of exemplary sensor electrode arrangements, according to one embodiment.

FIG. 4A illustrates an exemplary arrangement for transmitting multiplexed signals, according to one embodiment.

FIGS. 4B and 4C illustrate application of an exemplary digital code for transmitting multiplexed signals, according to one embodiment.

FIG. 5 illustrates an exemplary input device comprising coupling circuitry for charge sharing, according to one embodiment.

FIG. 6 is a timing diagram showing exemplary operation of coupling circuitry within a sensing cycle, according to one embodiment.

FIG. 7 is a method of transmitting signals using charge sharing, according to one embodiment.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the disclosure or the application and uses of the disclosure. Furthermore, there is no intention to be bound by any expressed or implied theory presented in the preceding background, summary, or in the following detailed description.

Embodiments described herein generally include an input device and associated processing system and method for charge sharing between transmitter electrodes of a group defined by a selected multiplexing scheme. Performing multiplexing of signals using techniques such as code-division multiplexing (CDM) may be traditionally performed using smaller groups transmitter electrodes to achieve a reduced power consumption and/or to achieve smaller computational overhead. However, using a greater number of transmitter electrodes may be beneficial to increase a signal-to-noise ration (SNR) of the input device and to improve input sensing performance. An increased SNR may further permit input sensing to be completed during a shorter sensing period, which may allow additional time for performing other processing functions such as display updating. Thus, the charge sharing techniques discussed herein may reduce power consumption while improving sensing performance.

### Exemplary Input Device Implementations

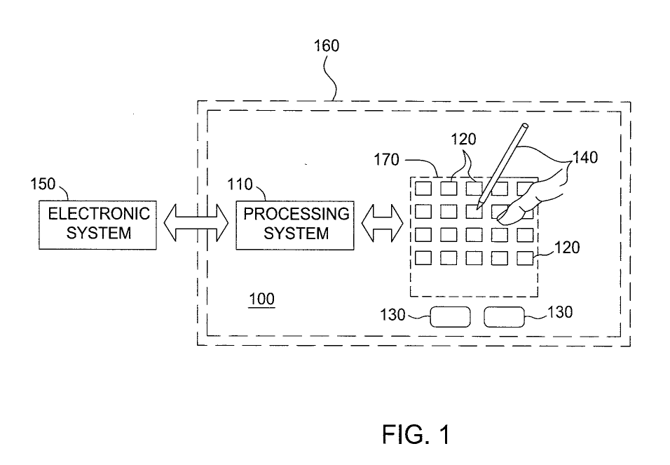

FIG. 1 is a schematic block diagram of an input device 100, in accordance with embodiments of the present technology. In various embodiments, input device 100 comprises a display device integrated with a sensing device. The input device 100 may be configured to provide input to an electronic system 150. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 170. Example input objects include fingers and styli, as shown in FIG. 1.

Sensing region 170 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 170 extends from a surface of the input device 100 in one or more directions into space until signal-to-noise ratios prevent sufficiently accurate object detection. The distance to which this sensing region 170 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 170 has a rectangular shape when projected onto an input surface of the input device 100.

The input device 100 may utilize any combination of sensor components and sensing technologies to detect user input in the sensing region 170. The input device 100 comprises a plurality of sensor electrodes 120 for detecting user input. The input device 100 may include one or more sensor electrodes 120 that are combined to form sensor electrodes. As several non-limiting examples, the input device 100 may use capacitive, elastive, resistive, inductive, magnetic acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensor electrodes 120 pickup loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensor electrodes 120 to create electric fields. In some capacitive implementations, separate sensor electrodes 120 may be ohmically shorted together to form larger sensor electrodes. Some capacitive implementations utilize resistive sheets, which may be uniformly resistive.

As discussed above, some capacitive implementations utilize “self-capacitance” (or “absolute capacitance”) sensing methods based on changes in the capacitive coupling between sensor electrodes 120 and an input object. In one embodiment, processing system 110 is configured to drive a voltage with known amplitude onto the sensor electrode 120 and measure the amount of charge required to charge the sensor electrode to the driven voltage. In other embodiments, processing system 110 is configured to drive a known current and measure the resulting voltage. In various embodiments, an input object near the sensor electrodes 120 alters the electric field near the sensor electrodes 120, thus changing the measured capacitive coupling. In one implementation, an absolute capacitance sensing method operates by modulating sensor electrodes 120 with respect to a reference voltage (e.g. system ground) using a modulated signal, and by detecting the capacitive coupling between the sensor electrodes 120 and input objects 140.

Additionally as discussed above, some capacitive implementations utilize “mutual capacitance” (or “transcapacitance”) sensing methods based on changes in the capacitive coupling between sensing electrodes. In various embodiments, an input object 140 near the sensing electrodes alters the electric field between the sensing electrodes, thus changing the measured capacitive coupling. In one implementation, a transcapacitive sensing method operates by detecting the capacitive coupling between one or more transmitter sensing electrodes (also “transmitter electrodes”) and one or more receiver sensing electrodes (also “receiver electrodes”) as further described below. Transmitter sensing electrodes may be modulated relative to a reference voltage (e.g., system ground) to transmit a transmitter signals. Receiver sensing electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensing electrodes may be dedicated transmitter electrodes or receiver electrodes, or may be configured to both transmit and receive.

In FIG. 1, the processing system 110 is shown as part of the input device 100. The processing system 110 is configured to operate the hardware of the input device 100 to detect input in the sensing region 170. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes. In some embodiments, the processing system 110 also comprises electronically-readable instructions, such as firmware code, software code, and/or the like. In some embodiments, components composing the processing system 110 are located together, such as near sensor electrode(s) 120 of the input device 100. In other embodiments, components of processing system 110 are physically separate with one or more components close to sensor electrode(s) 120 of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensor electrodes 120 to detect input, identification modules configured to identify gestures such as mode changing gestures, and mode changing modules for changing operation modes. Processing system 110 may also comprise one or more controllers.

In some embodiments, the processing system 110 responds to user input (or lack of user input) in the sensing region 170 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensor electrode(s) 120 of the input device 100 to produce electrical signals indicative of input (or lack of input) in the sensing region 170. The processing system 110 may perform any appropriate amount of processing on the electrical signals in producing the information provided to the electronic system. For example, the processing system 110 may digitize analog electrical signals obtained from the sensor electrodes 120. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 170, or some other functionality. FIG. 1 shows buttons 130 near the sensing region 170 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 170 overlaps at least part of an active area of a display screen of the display device 160. For example, the input device 100 may comprise substantially transparent sensor electrodes 120 overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display device 160 may share physical elements. For example, some embodiments may utilize some of the same electrical components for displaying and sensing. As another example, the display device 160 may be operated in part or in total by the processing system 110.

It should be understood that while many embodiments of the present technology are described in the context of a fully functioning apparatus, the mechanisms of the present technology are capable of being distributed as a program product (e.g., software) in a variety of forms. For example, the mechanisms of the present technology may be implemented and distributed as a software program on information bearing media that are readable by electronic processors (e.g., non-transitory computer-readable and/or recordable/writable information bearing media readable by the processing system 110). Additionally, the embodiments of the present technology apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

### Exemplary Sensor Electrode Arrangements

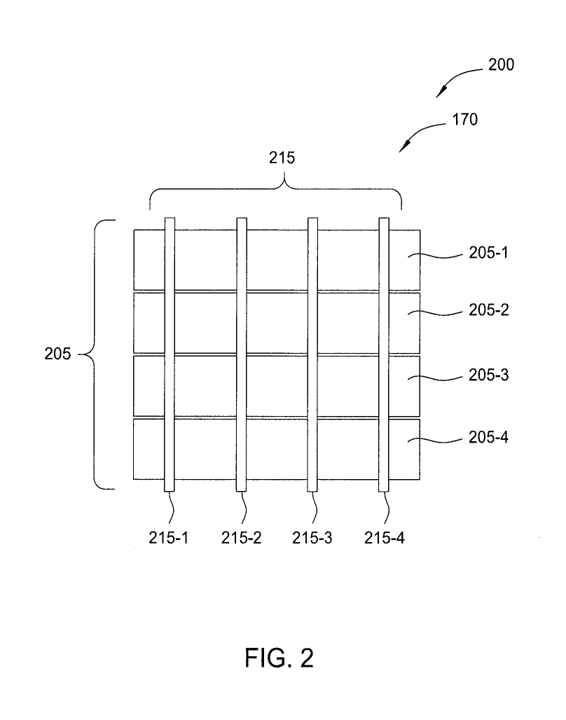

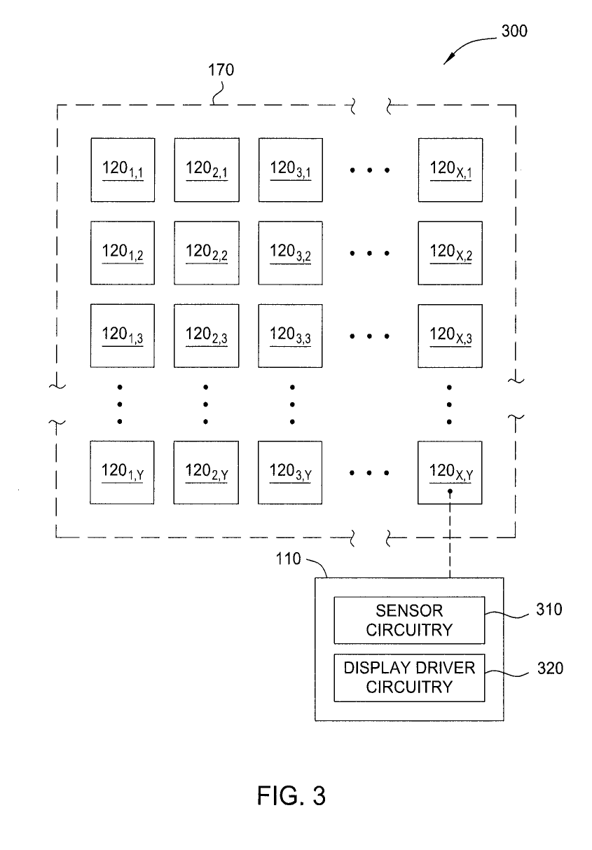

FIGS. 2 and 3 illustrate portions of exemplary sensor electrode arrangements, according to embodiments described herein. Specifically, arrangement 200 (FIG. 2) illustrates a portion of a pattern of sensor electrodes configured to sense in a sensing region 170 associated with the pattern, according to several embodiments. For clarity of illustration and description, FIG. 2 shows the sensor electrodes in a pattern of simple rectangles, and does not show various associated components. This pattern of sensing electrodes comprises a first plurality of sensor electrodes 205 (e.g., 205-1, 205-2, 205-3, 205-4), and a second plurality of sensor electrodes 215 (e.g., 215-1, 215-2, 215-3, 215-4). The sensor electrodes 205, 215 are each examples of the sensor electrodes 120 discussed above. In one embodiment, processing system 110 operates the first plurality of sensor electrodes 205 as a plurality of transmitter electrodes, and the second plurality of sensor electrodes 215 as a plurality of receiver electrodes. In another embodiment, processing system 110 operates the first plurality of sensor electrodes 205 and the second plurality of sensor electrodes 215 as absolute capacitive sensing electrodes.

The first plurality of sensor electrodes 205 and the second plurality of sensor electrodes 215 are typically ohmically isolated from each other. That is, one or more insulators separate the first plurality of sensor electrodes 205 and the second plurality of sensor electrodes 215 and prevent them from electrically shorting to each other. In some embodiments, the first plurality of sensor electrodes 205 and the second plurality of sensor electrodes 215 may be disposed on a common layer. The pluralities of sensor electrodes 205, 215 may be electrically separated by insulative material disposed between them at cross-over areas; in such constructions, the first plurality of sensor electrodes 205 and/or the second plurality of sensor electrodes 215 may be formed with jumpers connecting different portions of the same electrode. In some embodiments, the first plurality of sensor electrodes 205 and the second plurality of sensor electrodes 215 are separated by one or more layers of insulative material. In some embodiments, the first plurality of sensor electrodes 205 and the second plurality of sensor electrodes 215 are separated by one or more substrates; for example, they may be disposed on opposite sides of the same substrate, or on different substrates that are laminated together.

The pluralities of sensor electrodes 205, 215 may be formed into any desired shapes. Moreover, the size and/or shape of the sensor electrodes 205 may be different than the size and/or shape of the sensor electrodes 215. Additionally, sensor electrodes 205, 215 located on a same side of a substrate may have different shapes and/or sizes. In one embodiment, the first plurality of sensor electrodes 205 may be larger (e.g., having a larger surface area) than the second plurality of sensor electrodes 215, although this is not a requirement. In other embodiments, the first and second pluralities of sensor electrodes 205, 215 may have a similar size and/or shape.

In one embodiment, the first plurality of sensor electrodes 205 extends substantially in a first direction while the second plurality of sensor electrodes 215 extends substantially in a second direction. For example, and as shown in FIG. 2, the first plurality of sensor electrodes 205 extend in one direction, while the second plurality of sensor electrodes 215 extend in a direction substantially orthogonal to the sensor electrodes 205. Other orientations are also possible (e.g., parallel or other relative orientations).

In some embodiments, both the first and second pluralities of sensor electrodes 205, 215 are located outside of a plurality (or display stack) of layers that together form the display device 160. One example of a display stack may include layers such as a lens layer, a one or more polarizer layers, a color filter layer, one or more display electrodes layers, a display material layer, a thin-film transistor (TFT) glass layer, and a backlight layer. However, other arrangements of a display stack are possible. In other embodiments, one or both of the first and second pluralities of sensor electrodes 205, 215 are located within the display stack, whether included as part of a display-related layer or a separate layer. For example, Vcom electrodes within a particular display electrode layer can be configured to perform both display updating and capacitive sensing.

Arrangement 300 of FIG. 3 illustrates a portion of a pattern of sensor electrodes configured to sense in sensing region 170, according to several embodiments. For clarity of illustration and description, FIG. 3 shows the sensor electrodes 120 in a pattern of simple rectangles and does not show other associated components. The exemplary pattern comprises an array of sensor electrodes 120_{X,Y} arranged in X columns and Y rows, wherein X and Y are positive integers, although one of X and Y may be zero. It is contemplated that the pattern of sensor electrodes 120 may have other configurations, such as polar arrays, repeating patterns, non-repeating patterns, a single row or column, or other suitable arrangement. Further, in various embodiments the number of sensor electrodes 120 may vary from row to row and/or column to column. In one embodiment, at least one row and/or column of sensor electrodes 120 is offset from the others, such it extends further in at least one direction than the others. The sensor electrodes 120 is coupled to the processing system 110 and utilized to determine the presence (or lack thereof) of an input object in the sensing region 170.

In a first mode of operation, the arrangement of sensor electrodes 120 (120_{1,1}, 120_{2,1}, 120_{3,1}, . . . , 120_{X,Y}) may be utilized to detect the presence of an input object via absolute sensing techniques. That is, processing system 110 is configured to modulate sensor electrodes 120 to acquire measurements of changes in capacitive coupling between the modulated sensor electrodes 120 and an input object to determine the position of the input object. Processing system 110 is further configured to determine changes of absolute capacitance based on a measurement of resulting signals received with sensor electrodes 120 which are modulated.

In some embodiments, the arrangement 300 includes one or more grid electrodes (not shown) that are disposed between at least two of the sensor electrodes 120. The grid electrode(s) may at least partially circumscribe the plurality of sensor electrodes 120 as a group, and may also, or in the alternative, completely or partially circumscribe one or more of the sensor electrodes 120. In one embodiment, the grid electrode is a planar body having a plurality of apertures, where each aperture circumscribes a respective one of the sensor electrodes 120. In other embodiments, the grid electrode(s) comprise a plurality of segments that may be driven individually or in groups or two or more segments. The grid electrode(s) may be fabricated similar to the sensor electrodes 120. The grid electrode(s), along with sensor electrodes 120, may be coupled to the processing system 110 utilizing conductive routing traces and used for input object detection.

The sensor electrodes 120 are typically ohmically isolated from each other, and are also ohmically isolated from the grid electrode(s). That is, one or more insulators separate the sensor electrodes 120 and grid electrode(s) and prevent them from electrically shorting to each other. In some embodiments, the sensor electrodes 120 and grid electrode(s) are separated by an insulative gap, which may be filled with an electrically insulating material, or may be an air gap. In some embodiments, the sensor electrodes 120 and the grid electrode(s) are vertically separated by one or more layers of insulative material. In some other embodiments, the sensor electrodes 120 and the grid electrode(s) are separated by one or more substrates; for example, they may be disposed on opposite sides of the same substrate, or on different substrates. In yet other embodiments, the grid electrode(s) may be composed of multiple layers on the same substrate, or on different substrates. In one embodiment, a first grid electrode may be formed on a first substrate (or a first side of a substrate) and a second grid electrode may be formed on a second substrate (or a second side of a substrate). For example, a first grid electrode comprises one or more common electrodes disposed on a thin-film transistor (TFT) layer of the display device 160 (FIG. 1) and a second grid electrode is disposed on the color filter glass of the display device 160. The dimensions of the first and second grid electrodes can be equal or differ in at least one dimension.

In a second mode of operation, the sensor electrodes 120 (120_{1,1}, 120_{2,1}, 120_{3,1}, . . . , 120_{X,Y}) may be utilized to detect the presence of an input object via transcapacitive sensing techniques when a transmitter signal is driven onto the grid electrode(s). That is, processing system 110 is configured to drive the grid electrode(s) with a transmitter signal and to receive resulting signals with each sensor electrode 120, where a resulting signal comprising effects corresponding to the transmitter signal, which is utilized by the processing system 110 or other processor to determine the position of the input object.

In a third mode of operation, the sensor electrodes 120 may be split into groups of transmitter and receiver electrodes utilized to detect the presence of an input object via transcapacitive sensing techniques. That is, processing system 110 may drive a first group of sensor electrodes 120 with a transmitter signal and receive resulting signals with the second group of sensor electrodes 120, where a resulting signal comprising effects corresponding to the transmitter signal. The resulting signal is utilized by the processing system 110 or other processor to determine the position of the input object.

The input device 100 may be configured to operate in any one of the modes described above. The input device 100 may also be configured to switch between any two or more of the modes described above.

The areas of localized capacitive sensing of capacitive couplings may be termed “capacitive pixels,” “touch pixels,” “tixels,” etc. Capacitive pixels may be formed between an individual sensor electrode 120 and a reference voltage in the first mode of operation, between the sensor electrodes 120 and grid electrode(s) in the second mode of operation, and between groups of sensor electrodes 120 used as transmitter and receiver electrodes (e.g., arrangement 200 of FIG. 2). The capacitive coupling changes with the proximity and motion of input objects in the sensing region 170 associated with the sensor electrodes 120, and thus may be used as an indicator of the presence of the input object in the sensing region of the input device 100.

In some embodiments, the sensor electrodes 120 are “scanned” to determine these capacitive couplings. That is, in one embodiment, one or more of the sensor electrodes 120 are driven to transmit transmitter signals. Transmitters may be operated such that one transmitter electrode transmits at one time, or such that multiple transmitter electrodes transmit at the same time. Where multiple transmitter electrodes transmit simultaneously, the multiple transmitter electrodes may transmit the same transmitter signal and thereby produce an effectively larger transmitter electrode. Alternatively, the multiple transmitter electrodes may transmit different transmitter signals. For example, multiple transmitter electrodes may transmit different transmitter signals according to one or more coding schemes that enable their combined effects on the resulting signals of receiver electrodes to be independently determined. In one embodiment, multiple transmitter electrodes may simultaneously transmit the same transmitter signal while the receiver electrodes receive the effects and are measured according to a scanning scheme.

The sensor electrodes 120 configured as receiver sensor electrodes may be operated singly or multiply to acquire resulting signals. The resulting signals may be used to determine measurements of the capacitive couplings at the capacitive pixels. Processing system 110 may be configured to receive with the sensor electrodes 120 in a scanning fashion and/or a multiplexed fashion to reduce the number of simultaneous measurements to be made, as well as the size of the supporting electrical structures. In one embodiment, one or more sensor electrodes are coupled to a receiver of processing system 110 via a switching element such as a multiplexer or the like. In such an embodiment, the switching element may be internal to processing system 110 or external to processing system 110. In one or more embodiments, the switching elements may be further configured to couple a sensor electrode 120 with a transmitter or other signal and/or voltage potential. In one embodiment, the switching element may be configured to couple more than one receiver electrode to a common receiver at the same time.

In other embodiments, “scanning” sensor electrodes 120 to determine these capacitive couplings comprises modulating one or more of the sensor electrodes and measuring an absolute capacitance of the one or sensor electrodes. In another embodiment, the sensor electrodes may be operated such that more than one sensor electrode is driven and received with at a time. In such embodiments, an absolute capacitive measurement may be obtained from each of the one or more sensor electrodes 120 simultaneously. In one embodiment, each of the sensor electrodes 120 are simultaneously driven and received with, obtaining an absolute capacitive measurement simultaneously from each of the sensor electrodes 120. In various embodiments, processing system 110 may be configured to selectively modulate a portion of sensor electrodes 120. For example, the sensor electrodes may be selected based on, but not limited to, an application running on the host processor, a status of the input device, and an operating mode of the sensing device. In various embodiments, processing system 110 may be configured to selectively shield at least a portion of sensor electrodes 120 and to selectively shield or transmit with the grid electrode(s) 122 while selectively receiving and/or transmitting with other sensor electrodes 120.

A set of measurements from the capacitive pixels form a “capacitive image” (also “capacitive frame”) representative of the capacitive couplings at the pixels. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

In any of the above embodiments, multiple sensor electrodes 120 may be ganged together such that the sensor electrodes 120 are simultaneously modulated or simultaneously received with. As compared to the methods described above, ganging together multiple sensor electrodes may produce a coarse capacitive image that may not be usable to discern precise positional information. However, a coarse capacitive image may be used to sense presence of an input object. In one embodiment, the coarse capacitive image may be used to move processing system 110 or the input device 100 out of a “doze” mode or low-power mode. In one embodiment, the coarse capacitive image may be used to move a capacitive sensing IC out of a “doze” mode or low-power mode. In another embodiment, the coarse capacitive image may be used to move at least one of a host IC and a display driver out of a “doze” mode or low-power mode. The coarse capacitive image may correspond to the entire sensor area or only to a portion of the sensor area.

The background capacitance of the input device 100 is the capacitive image associated with no input object in the sensing region 170. The background capacitance changes with the environment and operating conditions, and may be estimated in various ways. For example, some embodiments take “baseline images” when no input object is determined to be in the sensing region 170, and use those baseline images as estimates of their background capacitances. The background capacitance or the baseline capacitance may be present due to stray capacitive coupling between two sensor electrodes, where one sensor electrode is driven with a modulated signal and the other is held stationary relative to system ground, or due to stray capacitive coupling between a receiver electrode and nearby modulated electrodes. In many embodiments, the background or baseline capacitance may be relatively stationary over the time period of a user input gesture.

Capacitive images can be adjusted for the background capacitance of the input device 100 for more efficient processing. Some embodiments accomplish this by “baselining” measurements of the capacitive couplings at the capacitive pixels to produce a “baselined capacitive image.” That is, some embodiments compare the measurements forming a capacitance image with appropriate “baseline values” of a “baseline image” associated with those pixels, and determine changes from that baseline image.

In some touch screen embodiments, one or more of the sensor electrodes 120 comprise one or more display electrodes used in updating the display of the display screen. The display electrodes may comprise one or more elements of the active matrix display such as one or more segments of a segmented Vcom electrode (common electrode(s)), a source drive line, gate line, an anode sub-pixel electrode or cathode pixel electrode, or any other suitable display element. These display electrodes may be disposed on an appropriate display screen substrate. For example, the common electrodes may be disposed on the a transparent substrate (a glass substrate, TFT glass, or any other transparent material) in some display screens (e.g., In-Plane Switching (IPS), Fringe Field Switching (FFS) or Plane to Line Switching (PLS) Organic Light Emitting Diode (OLED)), on the bottom of the color filter glass of some display screens (e.g., Patterned Vertical Alignment (PVA) or Multi-domain Vertical Alignment (MVA)), over an emissive layer (OLED), etc. In such embodiments, the display electrode can also be referred to as a “combination electrode,” since it performs multiple functions. In various embodiments, each of the sensor electrodes 120 comprises one or more common electrodes. In other embodiments, at least two sensor electrodes 120 may share at least one common electrode. While the following description may describe that sensor electrodes 120 and/or grid electrode(s) comprise one or more common electrodes, various other display electrodes as describe above may also be used in conjunction with the common electrode or as an alternative to the common electrodes. In various embodiments, the sensor electrodes 120 and grid electrode(s) comprise the entire common electrode layer (Vcom electrode).

In various touch screen embodiments, the “capacitive frame rate” (the rate at which successive capacitive images are acquired) may be the same or be different from that of the “display frame rate” (the rate at which the display image is updated, including refreshing the screen to redisplay the same image). In various embodiments, the capacitive frame rate is an integer multiple of the display frame rate. In other embodiments, the capacitive frame rate is a fractional multiple of the display frame rate. In yet further embodiments, the capacitive frame rate may be any fraction or integer multiple of the display frame rate. In one or more embodiments, the display frame rate may change (e.g., to reduce power or to provide additional image data such as a 3D display information) while touch frame rate maintains constant. In other embodiment, the display frame rate may remain constant while the touch frame rate is increased or decreased.

Continuing to refer to FIG. 3, the processing system 110 coupled to the sensor electrodes 120 includes a sensor circuitry 310 and optionally, a display driver circuitry 320. The sensor circuitry 310 includes circuitry configured to drive at least one of the sensor electrodes 120 for capacitive sensing during periods in which input sensing is desired. In one embodiment, the sensor circuitry 310 is configured to drive a modulated signal onto the at least one sensor electrode 120 to detect changes in absolute capacitance between the at least one sensor electrode and an input object. In another embodiment, the sensor circuitry 310 is configured to drive a transmitter signal onto the at least one sensor electrode 120 to detect changes in a transcapacitance between the at least one sensor electrode and another sensor electrode 120. The modulated and transmitter signals are generally varying voltage signals comprising a plurality of voltage transitions over a period of time allocated for input sensing. In various embodiments, the sensor electrodes 120 and/or grid electrode(s) may be driven differently in different modes of operation. In one embodiment, the sensor electrodes 120 and/or grid electrode(s) may be driven with signals (modulated signals, transmitter signals and/or shield signals) that may differ in any one of phase, amplitude, and/or shape. In various embodiments, the modulated signal and transmitter signal are similar in at least one of shape, frequency, amplitude, and/or phase. In other embodiments, the modulated signal and the transmitter signals are different in frequency, shape, phase, amplitude, and phase. The sensor circuitry 310 may be selectively coupled one or more of the sensor electrodes 120 and/or the grid electrode(s). For example, the sensor circuitry 310 may be coupled selected portions of the sensor electrodes 120 and operate in either an absolute or transcapacitive sensing mode. In another example, the sensor circuitry 310 may be a different portion of the sensor electrodes 120 and operate in either an absolute or transcapacitive sensing mode. In yet another example, the sensor circuitry 310 may be coupled to all the sensor electrodes 120 and operate in either an absolute or transcapacitive sensing mode.

The sensor circuitry 310 is configured to operate the grid electrode(s) as a shield electrode that may shield sensor electrodes 120 from the electrical effects of nearby conductors. In one embodiment, the processing system is configured to operate the grid electrode(s) as a shield electrode that may “shield” sensor electrodes 120 from the electrical effects of nearby conductors, and to guard the sensor electrodes 120 from grid electrode(s), at least partially reducing the parasitic capacitance between the grid electrode(s) and the sensor electrodes 120. In one embodiment, a shielding signal is driven onto the grid electrode(s). The shielding signal may be a ground signal, such as the system ground or other ground, or any other constant voltage (i.e., non-modulated) signal. In another embodiment, operating the grid electrode(s) as a shield electrode may comprise electrically floating the grid electrode. In one embodiment, grid electrode(s) are able to operate as an effective shield electrode while being electrode floated due to its large coupling to the other sensor electrodes. In other embodiment, the shielding signal may be referred to as a “guarding signal” where the guarding signal is a varying voltage signal having at least one of a similar phase, frequency, and amplitude as the modulated signal driven on to the sensor electrodes. In one or more embodiment, routing traces may be shielded from responding to an input object due to routing beneath the grid electrode(s) and/or sensor electrodes 120, and therefore may not be part of the active sensor electrodes, shown as sensor electrodes 120.

In one or more embodiments, capacitive sensing (or input sensing) and display updating may occur during at least partially overlapping periods. For example, as a common electrode is driven for display updating, the common electrode may also be driven for capacitive sensing. In another embodiment, capacitive sensing and display updating may occur during non-overlapping periods, also referred to as non-display update periods. In various embodiments, the non-display update periods may occur between display line update periods for two display lines of a display frame and may be at least as long in time as the display update period. In such embodiments, the non-display update period may be referred to as a “long horizontal blanking period,” “long h-blanking period” or a “distributed blanking period,” where the blanking period occurs between two display updating periods and is at least as long as a display update period. In one embodiment, the non-display update period occurs between display line update periods of a frame and is long enough to allow for multiple transitions of the transmitter signal to be driven onto the sensor electrodes 120. In other embodiments, the non-display update period may comprise horizontal blanking periods and vertical blanking periods. Processing system 110 may be configured to drive sensor electrodes 120 for capacitive sensing during any one or more of or any combination of the different non-display update times. Synchronization signals may be shared between sensor circuitry 310 and display driver circuitry 320 to provide accurate control of overlapping display updating and capacitive sensing periods with repeatably coherent frequencies and phases. In one embodiment, these synchronization signals may be configured to allow the relatively stable voltages at the beginning and end of the input sensing period to coincide with display update periods with relatively stable voltages (e.g., near the end of a input integrator reset time and near the end of a display charge share time). A modulation frequency of a modulated or transmitter signal may be at a harmonic of the display line update rate, where the phase is determined to provide a nearly constant charge coupling from the display elements to the receiver electrode, allowing this coupling to be part of the baseline image.

The sensor circuitry 310 includes circuitry configured to receive resulting signals with the sensor electrodes 120 and/or grid electrode(s) comprising effects corresponding to the modulated signals or the transmitter signals during periods in which input sensing is desired. The sensor circuitry 310 may determine a position of the input object in the sensing region 170 or may provide a signal including information indicative of the resulting signal to another module or processor, for example, a processor of the input device or of an associated electronic device 150 (i.e., a host processor), for determining the position of the input object in the sensing region 170.

The display driver circuitry 320 may be included in or separate from the processing system 110. The display driver circuitry 320 includes circuitry configured to provide display image update information to the display of the display device 160 during non-sensing (e.g., display updating) periods.

In one embodiment, the processing system 110 comprises a first integrated controller comprising the display driver circuitry 320 and at least a portion of the sensor circuitry 310 (i.e., transmitter module and/or receiver module). In another embodiment, the processing system 110 comprises a first integrated controller comprising the display driver circuitry 320 and a second integrated controller comprising the sensor circuitry 310. In yet another embodiment, the processing system comprises a first integrated controller comprising display driver circuitry 320 and a first portion of the sensor circuitry 310 (e.g., one of a transmitter module and a receiver module) and a second integrated controller comprising a second portion of the sensor circuitry 310 (e.g., the other one of the transmitter and receiver modules). In those embodiments comprising multiple integrated circuits, a synchronization mechanism may be coupled between them, configured to synchronize display updating periods, sensing periods, transmitter signals, display update signals, and the like.

In some embodiments a processor of the processing system 110 may be configured to determine a position of the input object in the sensing region 170. The processor may be further configured to perform other functions related to coordinating the operation of various components of the processing system 110. In an alternate embodiment, some or all of the functionality attributed to the processor may be provided by a processor external to the processing system 110 (e.g., a host processor of an associated electronic system).

### Exemplary Arrangements for Transmitting Multiplexed Signals

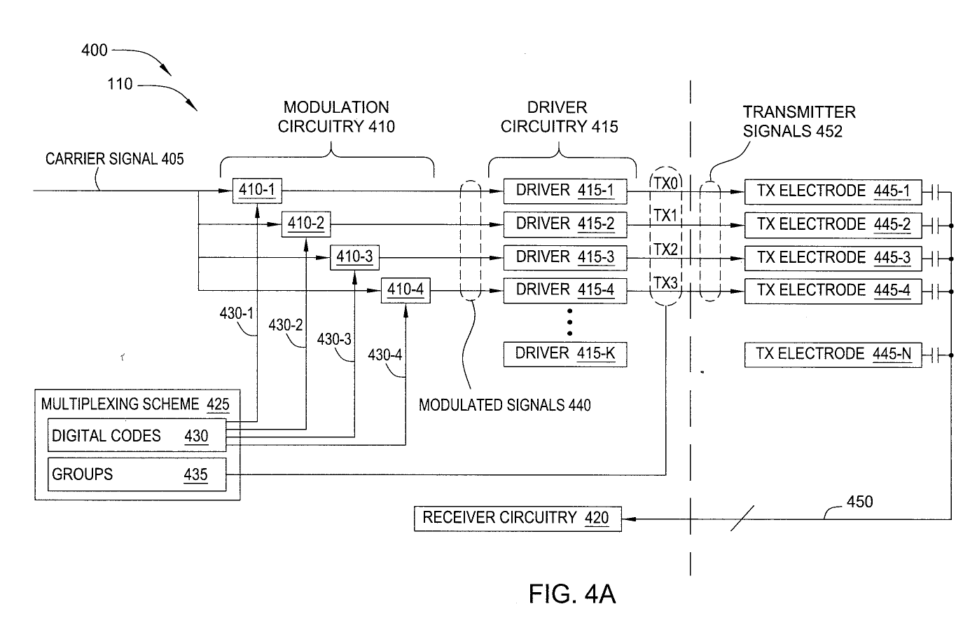

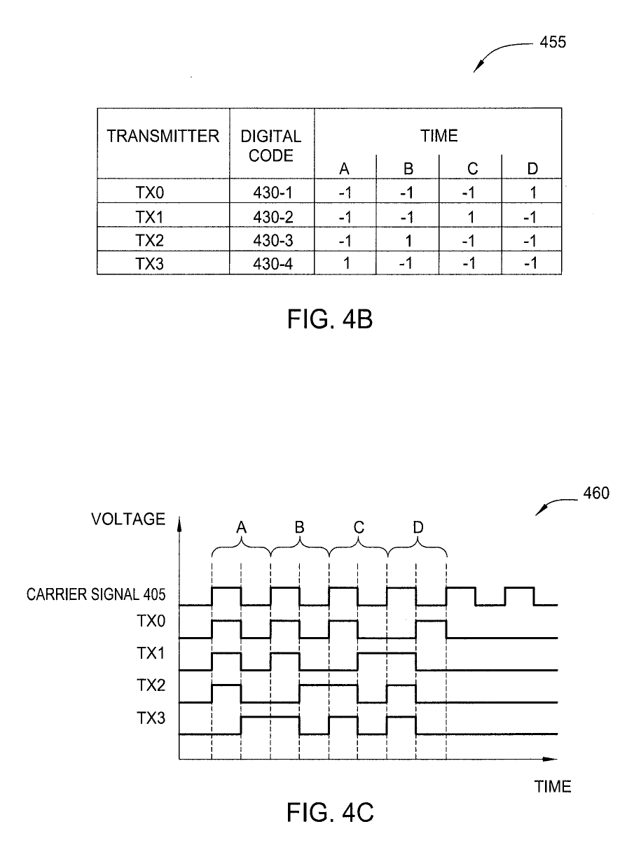

FIG. 4A illustrates an exemplary arrangement for transmitting multiplexed signals, according to one embodiment. More specifically, the multiplexed signals transmitted by arrangement 400 are suitable for performing capacitive sensing using a plurality of sensor electrodes, e.g., the sensor electrodes within arrangements 200, 300 discussed above.

The arrangement 400 includes processing system 110 coupled with a plurality of transmitter electrodes 445-1, 445-2, . . . , 445-N (collectively or generically, “transmitter electrodes 445”). Generally, the transmitter electrodes 445-1, 445-2, . . . , 445-N may represent sensor electrodes that are driven with transmitter signals 455 for performing capacitive sensing, whether operated within a transcapacitive sensing scheme or an absolute capacitive sensing scheme. In the absolute capacitive sensing scheme, the transmitter electrodes 445 electrodes may also be referred to as absolute capacitive sensor electrodes.

The processing system 110 comprises modulation circuitry 410, driver circuitry 415, and receiver circuitry 420. The modulation circuitry 410 is configured to modulate a carrier signal 405 based on a selected multiplexing scheme 425. More specifically, the modulation circuitry 410 applies a plurality of digital codes 430 to the carrier signal 405 to generate a plurality of modulated signals 440 (or “multiplexed signal 440”). In turn, the modulated signals 440 are driven by driver circuitry 415 as transmitter signals 455 onto the transmitter electrodes 445-1, . . . , 445-N. The resulting signals 450 are received by receiver circuitry through capacitive coupling(s) with the transmitter electrodes 445.

Each component signal of the plurality of modulated signals 440 is based on a separate digital code 430 defined according to the predefined multiplexing scheme 425. In some embodiments, the multiplexing scheme 425 is a code division multiplexing (CDM) scheme. In some embodiments, the digital codes 430 of a particular multiplexing scheme 425 are substantially orthogonal and mathematically independent relative to each other. In other embodiments, the digital codes 430 have a suitably low cross-correlation.

The digital codes 430 when applied to modulation circuitry 410 are configured to control one or more properties of the modulated signals 440. For example, the digital codes 430 may control one or more of amplitude, shape, frequency, phase, and polarity of the component signals within the particular multiplexing scheme 425. As used herein, “polarity” describes a phase of a component signal relative to the other component signals in the multiplexed signal 440. More specifically, the polarity may represent a 180-degree phase shift such that one or more component signals are inverted relative to other component signals. It will be noted that polarity relates to the logical levels of the component signal, such that any regime of voltage levels may be suitable.

In alternate embodiments, other properties of the component signals are controlled based on the selected multiplexing scheme 425, which may be in addition to or alternative to controlling the polarity of the component signals. For example, the modulation circuitry 410 may control one or more of amplitude, shape, frequency, and phase of the component signals within the particular multiplexing scheme 425. Furthermore, the modulated signals 440 need not be limited to controlling the different properties of the component signals between binary levels, but in some cases the component signal properties may correspond to three or more selectable levels for multiplexing the component signals.

In some embodiments, the processing system 110 selects one of a plurality of predefined groups 435 for transmitting the multiplexed transmitter signals 452. Each predefined group 435 comprises a plurality of the transmitter electrodes 445-1, . . . , 445-N. Moreover, different groups 435 may be defined based on the corresponding multiplexing scheme 425, and individual transmitter electrodes 445-1, . . . , 445-N may be included within the different groups 435. For example, a relatively low-power multiplexing scheme 425 may have smaller group sizes (i.e., fewer transmitter electrodes 445 per group 435) than a higher-power multiplexing scheme 425. Further, during operation the processing system 110 may dynamically select multiplexing schemes 425 and/or adaptively update groups 435 for achieving a desired level of sensing performance, reduced power consumption, and so forth. For example, the processing system 110 may dynamically transition from transmitting using groups 435 having a first number of transmitter electrodes 445, to transmitting using groups 435 having a second number of transmitter electrodes 445 greater or fewer than the first number of transmitter electrodes 445.

The transmitter electrodes 445 of each group 435 may have any suitable spatial arrangement. In one embodiment, the transmitter electrodes 445 within a group 435 are adjacent, which can correspond to a reduced complexity of processing sensing data and forming a capacitive image. In another embodiment, at least some of the transmitter electrodes 445 within a group 435 are non-adjacent. In one non-limiting example, the transmitter electrodes 445 within a group 435 may provide a “low-resolution” sensing mode by interleaving with other transmitter electrodes 445 not included in the group 435.

As shown, the selected group 435 includes four transmitter electrodes 445-1 to 445-4 configured to transmit the transmitter signals 452 on channels TX0-TX3. That is, each of the transmitter electrodes 445-1, . . . , 445-4 provides a respective channel TX0, . . . , TX3 used to transmit a particular component signal of the multiplexed transmitter signals 452. Generally, the number of transmitter electrodes 445 included within the selected group 435 (as shown, four) corresponds to a multiplexing scheme 425 having four distinct digital codes 430 used for generating the multiplexed transmitter signals 452.

In one embodiment, the different digital codes of an exemplary multiplexing scheme 425 are illustrated in chart 455 of FIG. 4B. Each element of the chart 455 represents a polarity of the corresponding component signal during a particular drive period (i.e., one or more clock cycles). Each row of the chart 455 represents a digital code 430-1, . . . , 430-4 transmitted over a corresponding channel TX0-TX3.

During a first time period A, component signals having a first polarity (corresponding to a “−1” value) are driven on channels TX0, TX1, and TX2 while a component signal having a second polarity (corresponding to a “1” value) is simultaneously driven on channel TX3. During a second time period B, component signals having the first polarity are driven on channels TX0, TX1, and TX3 while a component signal having the second polarity is driven on channel TX2, and so on. In this manner, the processing system 110 transmits a multiplexed signal (as seen in each column of the chart 455) during at least four time periods A-D. In one embodiment, the digital codes 430 (as seen in each row of the chart 455) are substantially orthogonal and mathematically independent relative to each other.

Transmitting the component signals using the transmitter electrodes 455 may be performed as part of a transcapacitive sensing scheme and/or an absolute capacitive sensing scheme. As discussed above, within a transcapacitive sensing scheme, resulting signals are received at sensor electrodes other than the driven transmitter electrodes 455: Within an absolute capacitive sensing scheme, the resulting signals are received at the same transmitter electrodes 455. As each of the transmitter electrodes 455 forms a capacitive coupling with the same or other sensor electrodes, resulting signals 450 based on the component signals transmitted on channels TX0-TX3 according to chart 455 may be received at four different receiver interfaces of the receiver circuitry 420.

The receiver circuitry 420 demodulates (or demultiplexes) the received resulting signals 450 using the applied digital codes 430 to produce a plurality of output signals. Generally, the demodulation is performed in two phases. In a first phase, the known digital codes 430 are used to recover the carrier signal comprising the effects of the input object. In a second phase, the carrier signal is removed and the effects of the input object are isolated in the plurality of output signals. Because the digital codes 430 are orthogonal, any interference (or leakage) caused by simultaneously transmitting the four component signals can be filtered out. That is, the orthogonal component signals permit the receiver circuitry 420 to eliminate the contribution of the other signals when evaluating each capacitive coupling with the transmitter electrodes 445-1, . . . , 445-4.

In one embodiment, the output signals produced by the receiver circuitry 420 may be used to determine positional information based on the location of the transmitter electrodes 445. In some embodiments, a capacitive image may be determined based on the output signals. Once the output signals are determined, measurements of change in the capacitive coupling between each transmitter electrode 445 and each of the plurality of receiver electrodes (whether in transcapacitive or absolute capacitive sensing schemes) may be determined based on the output signals. Alternately, in an absolute capacitive sensing mode, the change in the capacitive coupling corresponds to the driven transmitter electrode 445 (in this mode, alternately referred to as an “absolute capacitive sensing electrode”). In the absolute capacitive sensing mode, the processing system 110 may operate a specific driver 415 and a specific receiver of receiver circuitry 420, or may operate the receiver to modulate and receive the signal using the sensor electrode. For example, a positive terminal of an analog front-end (AFE) can be driven with a modulated signal based on the digital design.

In some embodiments, the component signals are substantially orthogonal in terms of time, frequency, or the like—i.e., the component signals exhibit very low cross-correlation, as is known in the art. In such embodiments, the component signals are based on substantially orthogonal codes. That is, two signals may be considered substantially orthogonal even when those signals do not exhibit a strict, zero cross-correlation.

In one embodiment, for example, the transmitted signals include pseudo-random sequence codes. In other embodiments, Walsh codes, Gold codes, Hadamard codes or other appropriate quasi-orthogonal or orthogonal codes are used. Regardless of whether the codes are orthogonal or substantially orthogonal, the codes generate a multiplexed signal that provides mathematically independent results. Moreover, the orthogonal codes may generate un-correlated resulting signals. The mathematical independence of the transmitted signals permits the input device to detect results corresponding to each of the simultaneous transmissions. In the example shown in the matrix above, four simultaneous transmissions generate four results and thus may quadruple the throughput for a given amount of time.

Moreover, many of the embodiments discussed herein disclose transmitting orthogonal (or substantially orthogonal) signals based on codes in a CDM scheme, however, the present disclosure is not limited to such. In general, any multiplexing scheme that enables transmitting multiple component signals simultaneously on multiple transmitter electrodes is within the scope of this disclosure. For example, instead of using digital codes to change the polarity of the transmitted signal, the processing system 110 may transmit a multiplexed signal with four component signals having orthogonal frequencies. That is, the processing system 110 may use an orthogonal frequency division multiplexing (OFDM) scheme which uses a plurality of orthogonal sub-carrier signals as the component signals. In this embodiment, each sensor electrode 120 within a group transmits a component signal with a different frequency where the frequencies vary during the different drive periods. In OFDM, each receiving sensor electrode would connect to an interface configured to detect signals at each of the different frequencies as well as to receive up to the maximum amount of voltage provided by all of the group transmitter electrodes. Similar to a CDM implementation, an OFDM demultiplexer is able to filter out the contributions of the other signals to a particular intersection of a transmitter and receiver electrode (i.e., the results are mathematically independent), thereby permitting the input device to derive positional information.

FIG. 4C illustrates a timing diagram 460 corresponding to operation of the arrangement 400. Specifically, the timing diagram 460 illustrates an application of the digital codes 430 provided in chart 455. Based on the digital codes 430, during the first drive period (Time A) the carrier signal 405 is driven onto each of channels TX0-TX2, and the inverse of carrier signal 405 (i.e., opposite polarity) is driven onto channel TX3 based on the polarity value of “1”. However, during the second drive period (Time B), the inverse of carrier signal 405 is driven onto channel TX2, while channels TX0, TX1, and TX3 transmit the carrier signal 405. This process generally continues until each channel TX0-TX3 has transmitted the inverse of the carrier signal 405 during a particular time period. The receiver circuitry 420 receives each of the component signals of the multiplexed signals transmitted during times A-D. After the demodulating the signals, the receiver circuitry 420 (or other downstream processing logic) decodes the signals using the digital codes. That is, the signals transmitted during the four drive periods are correlated to identify, for example, the capacitance or change of capacitance corresponding to a particular transmitter electrode 445.

For simplicity, during each time period A, . . . , D the carrier signal 405 is depicting as driving one sensing cycle comprising two half-cycles. Within each sensing cycle, the carrier signal 405 is at a first voltage level during a first half-cycle, and at a second voltage during a second half cycle. However, in some embodiments, a “burst” of a plurality of sensing cycles is driven during each time period A, . . . , D. In one non-limiting example, each burst corresponds to ten (10) sensing cycles.

The CDM digital codes used within the timing diagram 460 are presented for illustration purposes only. That is, so long as the different digital codes transmitted by the transmitter electrodes 455 are mathematically independent, the receiver circuitry 420 is able to filter out the effect of other channels on the channel of interest. Moreover, CDM may be used with any sized group (i.e., a number of transmitter electrodes 445 per group). For example, a group may include as few as two sensor electrodes but may include any larger number. Generally, increasing the membership of a group also increases the length of the digital codes, which may require more sophisticated logic and more computational overhead to demodulate the received multiplexed signals.

Performing multiplexing such as CDM using relatively fewer transmitter electrodes may be preferred for a reduced power consumption associated with driving the transmitter electrodes and due to smaller computational overhead, when compared with larger groupings. However, using a greater number of transmitter electrodes tends to increase SNR and improve input sensing performance. An increased SNR may further permit input sensing to be completed during a shorter sensing period, which may allow additional time for performing other processing functions such as display updating. Thus, the charge sharing techniques discussed herein may reduce power consumption while improving sensing performance.

### Exemplary Charge Sharing Implementations

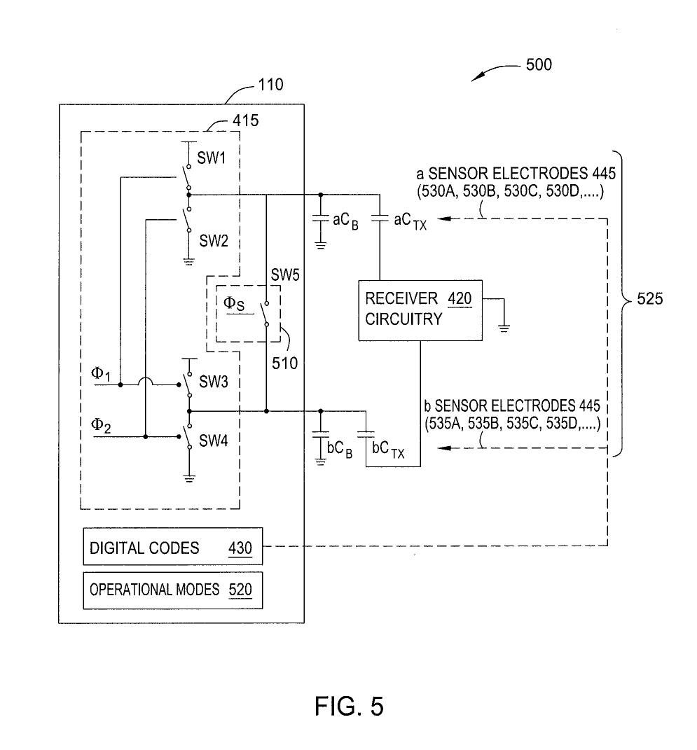

FIG. 5 illustrates an exemplary input device comprising coupling circuitry for charge sharing, according to one embodiment. Generally, the input device 500 may be used for reducing power consumption in conjunction with any of the various capacitive sensing arrangements discussed above.

The input device 500 comprises processing system 110 and a plurality of transmitter electrodes 445. The processing system 110 comprises driver circuitry 415, coupling circuitry 510, a plurality of digital codes 430, and one or more operational modes 520. For a particular group 525 of transmitter electrodes 445 defined for a selected multiplexing scheme, the driver circuitry 415 drives different portions of the group 525 with signals having different polarity, phase, frequency, amplitude, etc. based on the selected digital code 430.

As shown, the selected multiplexing scheme corresponds to a plurality of (a+b) transmitter electrodes 445 included within group 525. The transmitter electrodes 445 of the group 525 are not individually depicted, but are represented as a first portion of (a) transmitter electrodes 445 and a second portion of (b) transmitter electrodes 445. More specifically, the transmitter electrodes 445 of the first portion are represented as (a) times a capacitive coupling C_{TX} (that is, aC_{TX}) between a transmitting electrode and receiving electrode. The aC_{TX} value in turn is disposed in parallel with (a) times a background capacitive coupling C_{B} associated with the transmitter electrodes 445 of the first portion. Similarly, the transmitter electrodes 445 of the second portion are represented as (b) times the capacitive coupling C_{TX} (i.e., bC_{TX}) disposed in parallel with (b) times the background capacitive coupling C_{B}. It will be noted that the individual sensor electrodes 120 of the first and second portions need not have identical values of capacitive coupling value C_{TX} or background capacitive coupling C_{B}. Instead, the terms aC_{TX}, bC_{TX}, aC_{B}, bC_{B} are intended as an approximation of the relative capacitive coupling of the portions of sensor electrodes 120 defined within the multiplexing scheme.

Within the selected multiplexing scheme, a first portion of (a) transmitter electrodes 445 are driven to a first voltage, and a second portion of (b) transmitter electrodes 445 are driven to a second voltage less than the first voltage during a particular drive period. In some embodiments, each drive period corresponds to a sensing half-cycle of a plurality of sensing cycles. During a particular drive period, drive signals φ₁, φ₂ are provided to switches SW1, SW2, SW3, SW4 of the driver circuitry 415. Switches SW1, SW2 represent any suitable switching elements configured to conduct when the input signal is at a “high” value. Switches SW3, SW4 represent any suitable switching elements configured to conduct when the input signal is at a “low” value. One non-limiting example of the switches SW1, . . . , SW4 are metal-oxide-semiconductor field-effect transistors (MOSFETs).

Generally, the drive signals φ₁, φ₂ are driven to a “high” logic value during non-overlapping time periods. The drive signals φ₁, φ₂ may be driven to a “low” logic value during overlapping or non-overlapping time periods. Thus, when drive signal φ₁ is driven high, drive signal φ₂ is driven low. For example, when drive signal φ₁ is driven high, switch SW1 conducts and couples a positive voltage rail to the (a) transmitter electrodes 445 of the first portion. Switch SW3 is not conducting during this time. Because drive signal φ₂ is driven low, switch SW2 is not conducting but switch SW4 conducts and couples the (b) transmitter electrodes 445 of the first portion to ground.

The driver circuitry 415 is shown as selectively driving the transmitter electrodes 445 (aC_{TX}, bC_{TX}) between a first rail voltage (such as V_{DD}) and ground. However, alternate embodiments may drive the transmitter electrodes 445 between any other differing voltage levels suitable for performing capacitive sensing, whether between first and second positive voltages, a positive voltage and a negative voltage, ground and a negative voltage, first and second negative voltages, and so forth.

The coupling circuitry 510 may include any circuitry suitable for selectively coupling the first portion and second portion of transmitter electrodes 445 for conducting charge therebetween. As shown, coupling circuitry 510 comprises a switch SW5 controlled by a switching signal φs. Switch SW5 represents a switching element configured to conduct when the switching signal φs is at a “high” value (e.g., a n-type MOSFET), although this is not a requirement.

In some embodiments, the coupling circuitry 510 is configured to conduct after a drive period to drive the transmitter electrodes 445 of the group 525 to an intermediate voltage between the first voltage and the (lesser) second voltage. In this way, less charge is required during a subsequent drive period to drive transmitter electrodes 445 to the higher first voltage level, reducing both a required drive time and a power consumption of the driver circuitry 415. To illustrate using the example provided in chart 455 (FIG. 4B) and timing diagram 460 (FIG. 4C), and within a particular multiplexing scheme, during any particular time period A, B, C, or D, three (3) transmitter electrodes 445 correspond to a first polarity and one (1) transmitter electrode 445 corresponds to a second polarity. Thus, the value of (a) (i.e., the size of a first portion of transmitter electrodes 445) may be defined as three, and the value of (b) may be defined as one, or vice versa.

Notably, although the relative numbers (a) and (b) remain consistent during each time period A, B, C, and D, due to the multiplexing scheme the composition of the different portions may change for different time periods. In other words, individual transmitter electrode(s) 445 that are included in the first portion for one time period (corresponding to a first polarity) will included in the second portion for another time period (corresponding to a second polarity). For example, during time period A, the first portion 530A comprises (a) transmitter electrodes 445 corresponding to channels TX0, TX1, and TX2 corresponding to a first polarity, and the second portion 535A comprises (b) transmitter electrode 445 corresponding to channel TX3 corresponding to a second polarity. During time period B, the first portion 530B comprises (a) transmitter electrodes 445 corresponding to channels TX0, TX1, and TX3 while the second portion 535B comprises (b) transmitter electrode 445 corresponding to channel TX2. Thus, between time periods A and B the transmitter electrode 445 corresponding to channel TX2 transitions from the first portion 530A to the second portion 535B, and the transmitter electrode 445 corresponding to channel TX3 transitions from the second portion 535A to the first portion 530B.

Each of the time periods A, B, C, D are shown as corresponding to a respective sensing cycle. As discussed above, in some embodiments, a “burst” of a plurality of sensing cycles is driven during each time period A, . . . , D. During a first sensing half-cycle of time period A, the transmitter electrodes 445 of the first portion 530A and corresponding to channels TX0, TX1, and TX2 are driven to the first voltage level, and the transmitter electrode 445 of the second portion 535A and corresponding to channel TX3 is driven to the lower second voltage level. Before a second sensing half-cycle of time period A, the coupling circuitry 510 conducts for a period and charge is shared between the transmitter electrodes 445 corresponding to channels TX0-TX2 and TX3 to drive the transmitter electrode 445 corresponding to channel TX3 to an intermediate voltage greater than the second voltage level. In some embodiments, the transmitter electrodes 445 corresponding to channels TX0-TX2 and TX3 are all driven to the same intermediate voltage, but this is not a requirement. During the second sensing half-cycle of time period A, the transmitter electrode 445 of second portion 535A and corresponding to channel TX3 is driven from the intermediate voltage to the higher second voltage level. In some embodiments, the transmitter electrodes 445 of first portion 530A corresponding to channels TX0, TX1, and TX2 are driven from the intermediate voltage to the lower second voltage level. While charge sharing is shown as occurring between subsequent sensing half-cycles of a particular sensing cycle, similar techniques may be applied across different sensing cycles to reduce required drive time and power consumption.

In some embodiments, the operational modes 520 comprise a low-power “doze” mode. In the doze mode, the group 525 includes all of the transmitter electrodes 445 of the input device 500 and the first portion and second portion each comprise half of the transmitter electrodes 445. In this case, the first number (a) of transmitter electrodes 445 equals the second number (b) of transmitter electrodes 445. In one embodiment, the first portion and second portion define non-overlapping areas formed of contiguous transmitter electrodes 445. The doze mode may generally be used for performing a low-power, low-resolution sensing, such as face detection or proximity sensing. Performing charge sharing in a doze mode further reduces power consumption of the processing system 110.

In some embodiments, upon detecting an input object and/or predefined gesture within the doze mode, the processing system 110 transitions into another operational mode 520. For example, upon detecting the input object and/or the predefined gesture, the processing system 110 may operate using other multiplexing scheme(s). Furthermore, during operation the processing system may dynamically transition between different multiplexing schemes based on sensing performance requirements, power consumption limits, and so forth. In one non-limiting example, the processing system 110 transitions from a group size of four (4) transmitter electrodes to a group size of ten (10) transmitter electrodes based on increased sensing performance requirements.

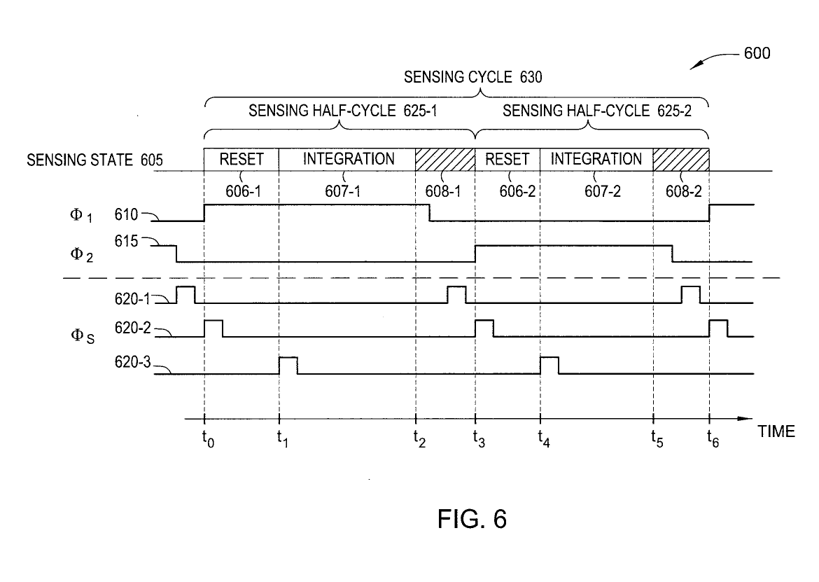

FIG. 6 is a timing diagram showing exemplary operation of coupling circuitry within a sensing cycle, according to one embodiment. More specifically, the timing diagram 600 illustrates a sensing cycle 630 comprising first and second half-cycles 625-1, 625-2. During the first half-cycle 625-1, the drive signal φ₁ (shown as plot 610) is driven to a “high” logical level and drive signal φ₂ (plot 615) is driven to a “low” logical level. During the second half-cycle 625-2 the drive signal φ₁ is driven to the “low” logical level and drive signal φ₂ is driven to the “high” logical level.

In some embodiments, the drive signals φ₁, φ₂ have a duty cycle of 50%, such that the drive signal φ₁ is driven to the high logical level during the entire first sensing half-cycle 625-1, and that drive signal φ₂ is driven to the high logical level during the entire second sensing half-cycle 625-2. In other embodiments, the drive signals φ₁, φ₂ have a duty cycle of less than 50%.

Within each sensing half-cycle 625-1, 625-2, the processing system operates within different sensing states indicated by plot 605. Between times t₀ and t₁, the processing system operates within a reset state during a first reset period 606-1, within which circuitry used for measuring received signals is generally returned to a known state prior to a subsequent measurement. Between times t₁ and t₂, the processing system operates within an integration state during an integration period 607-1, during which received signals corresponding to effects of driving the drive signals φ₁, φ₂ are measured.

In some embodiments, the processing system includes an optional period 608-1 within the sensing half-cycle 625-1 between times t₂ and t₃. The period 608-1 may be provided to ensure consistent baseline measurements, which helps provide increased sensing accuracy. The second sensing half-cycle 625-2 includes corresponding reset period 606-2, integration period 607-2, and optionally period 608-2.

The switching signal φₛ selectively couples the different portions of sensor electrodes to perform charge sharing during each sensing half-cycle 625-1, 625-2. The timing of switching signal φs for several example embodiments is shown using plots 620-1, 620-2, 620-3. Generally, during periods of charge sharing between portions of a group of transmitter electrodes, all of the switches SW1-SW4 of driver circuitry 415 are in a non-conducting state. Within plot 620-1, the switching signal is driven to a high logical value, thereby coupling the portions of sensor electrodes, during the periods 608-1, 608-2. Within plot 620-2, the switching signal couples the portions of sensor electrodes near the beginning of reset periods 606-1, 606-2. In this case, the drive signal φ₁ may be in a logical “low” state for at least a corresponding portion of the reset periods 606-1, 606-2. Generally, this timing may be used for embodiments in which a reset is performed by removing charge from the integrator and coupled sensor electrode. Additionally, by coupling the portions near the beginning of the reset period allows sufficient time for a voltage on the background capacitance to be well settled before performing a subsequent measurement. Within plot 620-3, the switching signal couples the portions of sensor electrodes near the beginning of integration periods 607-1, 607-2. In this case, the drive signal φ₁ may be in a logical “low” state for at least a corresponding portion of the integration periods 607-1, 607-2. Generally, this timing may be used for embodiments in which a reset is performed by resetting circuitry within an analog front-end of the processing system. Beneficially, these embodiments can reset the feedback capacitance of the receiver circuitry and other downstream elements to allow for the next signal to be measured.

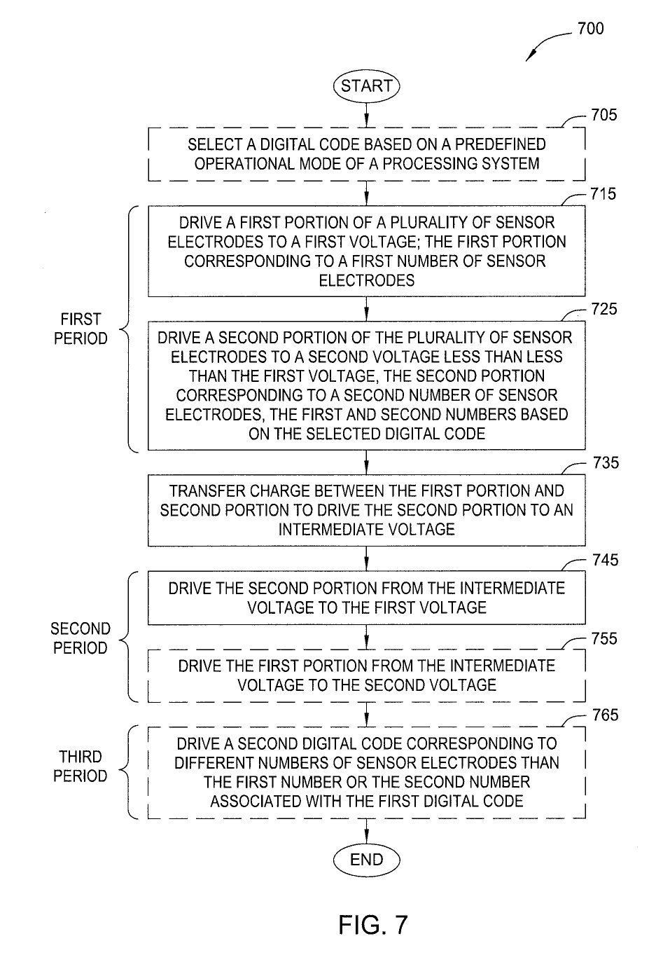

FIG. 7 is a method of transmitting signals using charge sharing, according to one embodiment. Generally, method 700 may be used with any of the input device and/or processing system embodiments that are discussed herein.

Method 700 begins at an optional block 705, where a digital code is selected based on a predefined operational mode of a processing system. In one embodiment, the predefined operational mode is a low-power (or “doze”) mode of the processing system. The digital code corresponds to a first multiplexing scheme applied to a first group of a plurality of sensor electrodes of the input device.

At block 715, a first portion of the plurality of sensor electrodes is driven to a first voltage. The first portion corresponds to a first number of sensor electrodes selected from the first group. At block 725, a second portion of the plurality of sensor electrodes is driven to a second voltage less than the first voltage. The second portion corresponds to a second number of sensor electrodes selected from the first group. Generally, the first and second numbers of sensor electrodes within each portion are based on the selected digital code. Blocks 715, 725 are performed during a first period and may be performed contemporaneously. In some embodiments, the first period comprises a first sensing half-cycle of a sensing cycle.

At block 735, charge is transferred between the first and second portions of the plurality of sensor electrodes within the first group, to drive the second portion to an intermediate voltage. In some embodiments, transferring charge is performed by transmitting a switching signal to coupling circuitry coupled with the first and second portions of the plurality of sensor electrodes.

At block 745, the second portion of the plurality of sensor electrodes is driven from the intermediate voltage to the first voltage. Generally, driving the plurality of sensor electrodes from the intermediate voltage reduces the amount of charge and/or time required to reach the first voltage. At block 755, the first portion of the portion of the plurality of sensor electrodes is optionally driven from the intermediate voltage to the second voltage. Blocks 745, 755 are performed during a second period and may be performed contemporaneously. In some embodiments, the second period comprises a second sensing half-cycle of a sensing cycle.

At block 765, a second digital code corresponding to different numbers of sensor electrodes is applied. The application of the second digital code is generally performed during a third period distinct from the first and second periods. The second digital code corresponds to a second multiplexing scheme applied to a second group of a plurality of sensor electrodes of the input device. In one embodiment, application of the second digital code is performed upon transitioning out of a low-power (or “doze”) mode of the processing system. In another embodiment, application of the second digital code is performed upon based on a change in sensing performing requirements and/or power consumption limits. Method 700 ends following completion of block 765.

Thus, the embodiments and examples set forth herein were presented in order to best explain the embodiments in accordance with the present technology and its particular application and to thereby enable those skilled in the art to make and use the disclosure. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

What is claimed is:

1. An input device comprising:
a plurality of sensor electrodes; and
a processing system configured to:
drive, during a first period, a first portion of the plurality of sensor electrodes to a first voltage, the first portion corresponding to a first number of sensor electrodes;
drive, during the first period, a second portion of the plurality of sensor electrodes to a second voltage less than the first voltage, the second portion corresponding to a second number of sensor electrodes, wherein the first number and the second number are based on a plurality of digital codes used to drive the first portion and second portion;
transfer charge between the first portion and second portion to drive the second portion to an intermediate voltage between the first voltage and the second voltage; and
drive, during a second period, at least one sensor electrode of the second portion from the intermediate voltage to the first voltage.

2. The input device of claim 1, wherein the processing system is further configured to:
drive, during the second period, the first portion from the intermediate voltage to the second voltage.

3. The input device of claim 1, wherein the first number of sensor electrodes equals the second number of sensor electrodes.

4. The input device of claim 1, wherein the first number of sensor electrodes differs from the second number of sensor electrodes.

5. The input device of claim 4, wherein the first number of sensor electrodes is greater than the second number of sensor electrodes.

6. The input device of claim 1, wherein a digital code is selected from the plurality of digital codes based on a predefined operational mode of the processing system.

7. The input device of claim 1, wherein a first digital code of the plurality of digital codes is applied during the first period and a second digital code of the plurality of digital codes is applied during a third period, wherein the second digital code corresponds to different numbers of sensor electrodes than the first number or the second number associated with the first digital code.

8. A processing system comprising:
driver circuitry configured to:
drive, during a first period, a first portion of a plurality of sensor electrodes to a first voltage, the first portion corresponding to a first number of sensor electrodes;
drive, during the first period, a second portion of the plurality of sensor electrodes to a second voltage less than the first voltage, the second portion corresponding to a second number of sensor electrodes, wherein the first number and second number are based on a plurality of digital codes used to drive the first portion and second portion; and
coupling circuitry configured to selectively couple the first portion and second portion, whereby the second portion is driven to an intermediate voltage between the first voltage and the second voltage,
wherein the driver circuitry is further configured to drive, during a second period, the second portion from the intermediate voltage to the first voltage.

9. The processing system of claim 8, wherein the driver circuitry is further configured to:
drive, during the second period, the first portion from the intermediate voltage to the second voltage.

10. The processing system of claim 8, wherein the first number of sensor electrodes equals the second number of sensor electrodes.

11. The processing system of claim 8, wherein a digital code is selected from the plurality of digital codes based on a predefined operational mode of the processing system.

12. The processing system of claim 8, wherein a first digital code of the plurality of digital codes is applied during the first period and a second digital code of the plurality of digital codes is applied during a third period, wherein the second digital code corresponds to different numbers of sensor electrodes than the first number or the second number associated with the first digital code.

13. The processing system of claim 8, wherein the driver circuitry is further configured to:
drive sensing signals comprising a first sensing half-cycle during the first period, and comprising a second sensing half-cycle during the second period.

14. The processing system of claim 13, wherein the coupling circuitry comprises a switching device, wherein the switching device is conducting between the first portion and second portion during a third period occurring between an end of the first period and a beginning of the second period.

15. A method comprising:
driving, during a first period and using driver circuitry, a first portion of a plurality of sensor electrodes to a first voltage, the first portion corresponding to a first number of sensor electrodes;
driving, during the first period and using the driver circuitry, a second portion of the plurality of sensor electrodes to a second voltage less than the first voltage, the second portion corresponding to a second number of sensor electrodes, wherein the first number and second number are based on a plurality of digital codes used to drive the first portion and second portion;
transferring charge between the first portion and second portion to drive the second portion to an intermediate voltage between the first voltage and the second voltage; and
driving, during a second period, the second portion from the intermediate voltage to the first voltage.

16. The method of claim 15, further comprising:
driving, during the second period, the first portion from the intermediate voltage to the second voltage.

17. The method of claim 15, wherein the first number of sensor electrodes equals the second number of sensor electrodes.

18. The method of claim 15, wherein the first number of sensor electrodes is greater than the second number of sensor electrodes.

19. The method of claim 15, further comprising:
selecting, based on a predefined operational mode of a processing system comprising the driver circuitry, a digital code from the plurality of digital codes.

20. The method of claim 15, wherein a first digital code of the plurality of digital codes is applied during the first period and a second digital code of the plurality of digital codes is applied during a third period, wherein the second digital code corresponds to different numbers of sensor electrodes than the first number or the second number associated with the first digital code.
